(19) United States
(12) Patent Application Publication
(10) Pub. No.: US 2007/0122527 A1
(43) Pub. Date: May 31, 2007

(54) Method for the industrialized baking in two steps of dual-component bakery products, dual-component bakery product obtained by such a method, and installation for carrying out such a method

(76) Inventor: Edwin Otto Maria Janus, Nuenen (NL)

Correspondence Address: David P Gordon;Gordon & Jacobson, 65 Woods End Road, Stamford, CT, 06905, US

(21) Appl. No.: 10/574,154

(22) PCT Filed: Oct. 11, 2004
(86) PCT No.: PCT/EP04/52499

§ 371 Date: Mar. 29, 2006

(30) Foreign Application Priority Data
Oct. 22, 2003 (NL) 1024587
Apr. 19, 2004 (NL) 1025971

(51) Int. Cl. A21D 13/00

(52) U.S. Cl. 426/94

(57) ABSTRACT

A method and system for baking a dual-component bakery product includes providing an uncooked product comprising an envelope, at least substantially made of dough, and a filling. The filling is heated by electromagnetic waves so as to initiate a cooking state. Subsequent to the heating of the filling, the envelope is baked in a heat transfer oven. Rising of the dough is advantageously also effected by means of the electromagnetic waves, preferably simultaneously with the heating of the filling for cooking the latter. The invention further includes a dual-component bakery product obtained by such methodology.

### BACKGROUND OF THE INVENTION

1. Field of the Invention

The invention relates in general to a method of baking dual-component bakery products, including, for example but not limited to, sausage rolls, meat pastries and the like.

2. State of the Art

Dual-component bakery products generally comprise an envelope and a filling. The envelope is mainly composed of dough, for example puff pastry in the case of meat pastries and bread dough in the case of sausage rolls. The filling often comprises mainly meat, such as minced meat or sausage, but vegetarian fillings are also known, for example seitan.

Conventionally, the industrial baking process takes place in a number of consecutive steps, such as shaping the sausage, placing the sausage on the dough, rolling the dough around the sausage, cutting the dough and sausage to size, allowing the dough to rise (for example for 60 minutes at approximately room temperature or slightly above), baking of the bread roll, and deep-freezing. It is noted that the term “sausage” in the present document denotes any substantially sausage-shaped mass of meaty substance. This mass is usually not surrounded by a membrane here, but it does have a certain shape of minced meat ingredients.

The invention thus in particular relates to a method for the industrialized baking of dual-component bakery products, which products comprise an envelope, at least substantially made of dough, and a filling, in which method the envelope is baked and the filling is cooked until done.

The relevant prior art baking process takes place in a hot-air oven at 260° for approximately 12 to 13 minutes in the case of sausage rolls. If the roll is heated by means of light and/or infrared radiation and/or convection, the sausage or other filling will substantially not receive heat except by transfer through the envelope. Cooking of the filling will take place from 65° onwards only. This means that the entire baking process takes much time and much energy. The invention does not relate to bakery products whose fillings are allowed to remain at a comparatively low temperature such as room temperature.

U.S. Pat. No. 6,322,832 describes a method of preparing frankfurters, hot dogs and other sausage products without envelopes by means of microwaves (cf. Abstract). In column 6, 11. 44-56, it is described that the sausage mass is first converted into a gel by heat, whereupon further heating takes place by other means. In column 9, 11. 6-14, a brief mention is made of an edible envelope which also passed through the microwave cavity for the purpose of “additional cooking”. The cited reference, however, makes no mention of a dough envelope and accordingly suggests that the entire process be carried out in a serial arrangement. This could indeed apply to a “skin” or such-like envelope. The present invention by contrast relates to bakery products, where the baking of the dough involves the relatively more complicated physical and chemical processes, and where nevertheless a considerable speeding-up of the production process can be realized.

### SUMMARY OF THE INVENTION

The present invention stems from the realization by the inventor that a shorter baking time and/or a higher production capacity and/or an energy saving can be achieved if the, in particular uncooked, filling is heated from the inside as it were, and that this can be advantageously implemented in that the baking process is carried out in two consecutive steps, i.e. first heating by means of electromagnetic waves and then by means of heat transfer from the outside. It was found to be advantageous first to start cooking the filling until done, and then to bake the envelope. The cooking of the filling may be continued during the second step, if so desired. A favorable choice of the preparation parameters will lead to an optimized product as regards firmness, crispiness and appearance of the envelope, and as regards flavor and physical attachment to the envelope, etc. of the filling.

It is accordingly among the objects of the present invention to provide a method of baking a dual-component product that requires less time and energy without detracting from the quality of the product.

According to one aspect of the invention, the method comprises two steps, i.e. first heating of the filling of the dual-component product by means of electromagnetic waves so as to initiate a cooking process, and subsequently baking of the envelope of the dual-component product in a heat transfer oven. The electromagnetic waves, such as microwaves, need be utilized for a short period only, whereas final baking of the product requires more time in order to achieve a good product.

It should be noted here that surprisingly good results have been obtained with the invention as regards the appearance and permanence of shape of the baked dough envelope in particular. The steam generated by the water in the dough was found not to lead to an unacceptable change in the shape thereof. In addition, said steam contributes to the cooking process of the filling.

It should further be noted that the present invention is also based on the following recognition. If e.g. a sausage is baked using electromagnetic waves, the color of the meat is less brown than in case of baking it in a furnace. This holds to some extent for the inner part of the sausage but in particular for the surface of the sausage. Such a paler color might be less appetizing, in particular with respect to the outside surface of the sausage. However, in a dual-component bakery product like a sausage roll, the sausage is covered by the dough and thus the consumer of the product does not see the outer surface of the sausage but merely cross-sections thereof made e.g. by a knife. The fact that these cross-sections do not show a (dark) brown color does not hamper the appetizing appearance of the dual-component bakery product.

A favorable embodiment of a method according to the invention is characterized in that the rising of the dual-component bakery products takes place through a treatment with electromagnetic waves. It was surprisingly found that such a treatment renders a separate rising step for the dough of the dual-component bakery product unnecessary. Normally rising takes approximately one hour at a temperature of, for example, 28° C., but with the treatment with electromagnetic waves no more than a few, for example two to three minutes. Since electromagnetic waves can be particularly homogeneous when generated in a microwave oven, the dual-component bakery products are also found to be particularly well-shaped, i.e. homogeneously risen. This modification of the method thus not only leads to a considerable saving in time, but it also yields a particularly attractive product.

In a preferred embodiment, the rising of the dough component of the dual-component bakery product is achieved by means of electromagnetic waves in the same step in which the filling is heated by electromagnetic waves so as to cook it until done. The method is particularly efficient and simple as a result of this. Upon heating to a core temperature (of the filling) equal to or above 95° C., for example, a sausage roll is obtained with a firm cell structure which remains intact also when compressed. It was also found to be possible to give a meat pastry a pre-treatment of a few minutes in a microwave oven such that it can be baked in a normal oven in approximately eight minutes well browned and with flaky pastry.

The invention also relates to a system suitable for carrying out the method according to the invention and to a bakery product prepared by the method according to the invention. Further advantageous aspects of the invention are recited in the dependent claims.

### DESCRIPTION OF THE DRAWING

The above and further properties, aspects, and advantages of the invention will now be discussed in more detail with reference to preferred embodiments of the invention, and in particular with reference to the appended Figures where:

FIG. 1 is a cross-sectional view of a microwave oven used in the invention;

FIG. 2 shows a detail of the microwave oven used in the invention; and

FIG. 3 shows a baking arrangement used in the invention with a series-parallel converter.

### DETAILED DESCRIPTION OF THE PREFERRED EMBODIMENTS

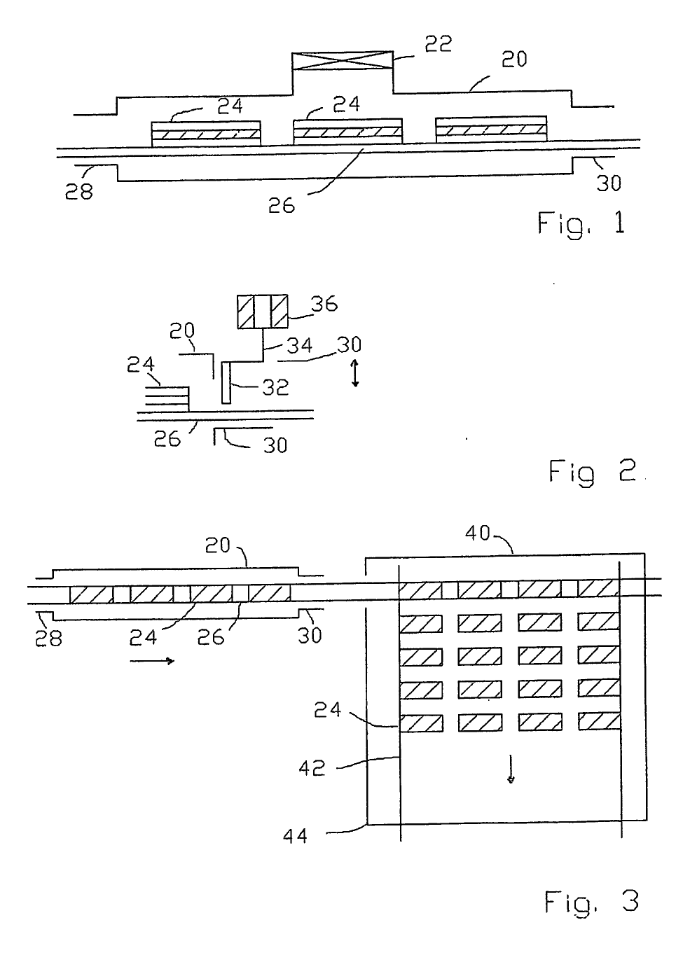

FIG. 1 shows a microwave oven used in the invention in cross-section. The oven comprises a resonance cavity 20 provided with a coupling device 22 for supplying the energy of the microwaves used. The generator of these waves is not shown for simplicity's sake. The tests described below were carried out with a conventional magnetron and a conventional oven for household use. Such a device will normally be of a heavier design for industrial applications, with a longer operational life as desired for continuous operation. This then relates to, for example, cooling of the outer wall, a larger volume, a stronger wave source, and possibly a different frequency used for the wave source, as applicable. The microwave oven may be used in the “batch” mode, i.e. the products are loaded into the microwave oven, the latter is energized for a short period (see below), and the bakery products are unloaded for further treatment. Preferably, however, a more continuous process is used wherein the bakery products 24 are supplied on a conveyor belt 26, as shown. The step of depositing the products on the belt 26 is not shown for simplicity's sake. Furthermore, the physical aspects of the baking process will not be discussed. It suffices to note that the water content of the filling ensures that a temperature of 100° C. will not be readily exceeded, that the microwave energy also has an effect on the appearance and composition of the envelope, and that the baking process in general is very complicated.

The products to be baked are fed into the microwave oven, for example, in the raw state. They have a filling (shown hatched) consisting of a minced meat product such as sausage or the like and an envelope that is shown in white. The shape of the product is a usual one such that in the case of a meat pastry the length may be, for example, 12 cm, the width 6 cm, and the thickness 2.5 cm; the filling extending over substantially the entire length of the product and having a width of 2.5 cm and a thickness of 1 cm. These dimensions, however, are by no means limitative, indeed mini meat pastries are well known. Furthermore, the advantages of the invention may lead to the use of dimensions, compositions, shapes, colors, etc. that were hitherto not usual. Similar values apply to sausage rolls; however, these are not discussed separately.

It was surprisingly found that the rising of the dough of the dual-component bakery product 24 can also take place in the microwave oven. A long rising process at 28° C. may thus be omitted.

The microwave oven is energized once the products have arrived in the oven. This energizing may take place continuously while at the same time the conveyor belt also moves continuously; alternatively, the oven and/or the conveyor belt may be energized intermittently. The latter takes place preferably (at least partly) if the process starts with deep-frozen ingredients. Defrosting thereof may take place at room temperature, but this takes (much) longer. As will be explained below, a heating time of 30 seconds up to a few minutes, for example at most 3 minutes, is a good choice, but longer or shorter times are equally possible, in dependence also on the microwave power and the average speed of the conveyor belt in relation to the oven size and the product to be prepared.

The atmosphere surrounding the dual-component bakery products 21 is preferably given an increased moisture level during the treatment of the bakery products 24 in the microwave oven. The microwave oven 24 is for this purpose preferably provided with means for keeping the moisture content in the resonance cavity high. Said means may comprise, for example, a steam moistening installation (not shown in the drawing).

The device as drawn is designed for continuous operation, the inlet opening 28 and the delivery opening being permanently open. Suitable measures are then to be taken so as to ensure that only a negligibly small microwave power can escape at said openings. Measures that are appropriate per se are formed, for example, in that said openings are shaped as microwave pipes with special arrangements comprising stubs acting as reflectors for the wavelength used for the centimeter or decimeter microwaves. Such arrangements are not unusual in microwave technology. Besides, the wave intensity becomes quickly less in such openings (tubes) as the distance increases owing to absorption by the wall, especially if the latter is coated with a radiation-absorbing material, and/or by the bakery products present in the inlet and delivery openings. These opening may then be constructed as tubes, for example, and be only slightly wider/higher than the bakery products being processed. As long as there are no bakery products present in the openings or the oven, furthermore, the microwave energy may be switched off by a blocking device that is present (not shown).

FIG. 2 shows a detail of a microwave oven used in the invention. The oven is discontinuously operated here, after the microwave resonance cavity has been closed off with a cover exactly in-between two bakery products 24. The closing mechanism comprises, for example, a transmission rod 34 that is driven in the direction of the arrow by an electromagnetic coil 36. A similar arrangement is present at the inlet opening in this case. Alternative closing arrangements are equally conceivable.

FIG. 3 shows a baking arrangement used in the invention with a series/parallel converter. The oven of FIG. 1 is shown in plan view here, the resonance cavity 20, the bakery products 24, the conveyor belt 26, and the inlet and delivery openings 28, 30 being visible. The conveyor belt 26 moves to the right and enters the oven 40. Here the products are taken over by a wide conveyor belt 42, for example in that they are pushed in lateral direction off the conveyor belt 26 by a mechanical pushing device (not shown). The conveyor belt 26 runs outside the plane of drawing underneath the ovens 20, 40 back to the inlet 28. The conveyor belt 42 moves in downward direction in the Figure and leaves the oven 40 at the delivery end 44 after completion of the baking time. The products are now ready for further treatment such as cooling down, packaging, delivering, or deep-freezing. These conventional operations are not described in any detail here. The oven 40 may operate on the basis of various technologies, such as radiation or convection. Whatever this technology, the heat is always supplied to the bakery products through transmission via the outside thereof. The conveyor belt 42 runs outside the plane of drawing back to the inlet of the oven 40. Good results are obtained at oven temperatures between 200 and 250°. Thus excellent results are obtained at approximately 250° and a baking time of, for example, approximately 5 minutes for (flaky) meat pastries and approximately 8 minutes for sausage rolls.

The arrangement of FIG. 3 shows two fully separated ovens interconnected by a transport device that drives the conveyor belt 26, while also a series/parallel rearrangement is effected. It is possible that this separation is less discrete, for example in that the spatial heating zones partly overlap and the heat transfer starts as early as at the delivery opening 30.

The Table below lists the results of a number of baking experiments.

| microwave | | | | | |
|---|---|---|---|---|---|
| oven | | | hot-air oven | | |
| power | time | | temperature | time | |
| (W) | (s) | result | (° C.) | (m′s″) | result |
| 400 | 30 | sausage | 200 | 10′00″ | done |
| | | done | | | |
| | | (65° C.) | | | |
| 400 | 30 | sausage | 210 | 8′15″ | done; well |
| | | done | | | browned |
| | | (65° C.) | | | |
| 400 | 30 | sausage | 250 | 5′30″ | done |
| | | done | | | |
| | | (65° C.) | | | |

The three columns on the left relate to the cooking of the filling; this is the same for all three cases with a microwave power of 400 W, a cooking time of 30 seconds, and a result of good quality. The three columns on the right relate to the baking in the hot-air oven, for which three different temperatures were used and an optimum baking time was empirically determined each time. A good-quality result was obtained in all three cases, the second line yielding the best product appearance. It should be noted that the test arrangement used was for only a single sausage roll. The respective power settings and oven volumes are to be adapted in upward direction in an industrial application. If the cooking time in the microwave oven is 30 seconds, and the baking time 8 minutes, the oven 40 must have a width of approximately 5 times the length of one sausage roll, i.e. 5×12 cm plus various interspacings, which is in a range of 70 to 100 cm. The length of the oven 40 must then be 8÷½=16 times the width of a sausage roll (being c. 6 cm) plus various interspacings, that is in a range of 1 10 to 150 cm. Alternative configurations are obviously possible. It is clear that the total processing time can be approximately halved. A similar improvement is achievable for a different oven technology.

The present invention was described above with reference to preferred embodiments thereof. Those skilled in the art will realize that numerous modifications may be applied therein without departing from the scope of the appended claims. The description should accordingly be regarded as illustrative rather than limitative, and no restrictions should be derived therefrom other than those mentioned in the claims. For example, although the invention is particularly suitable for dual-component bakery products with meat fillings, especially because stringent requirements are to be imposed here as regards sterility, the invention is in principle equally applicable to bakery products with a filling of vegetables or fruit, such as spring rolls or fruit pies. The invention is also applicable to dual-component bakery products whose envelope is realized by a bread dough, a flaky pastry, a winded risen dough (which is a mixture having properties somewhere in-between those of flaky pastry and bread dough), or other dough.

1. A method for baking a product comprising:
providing an uncooked product including an envelope and a filling, said envelope at least substantially made of dough;
subsequent to providing the uncooked product heating the filling by means of electromagnetic waves so as to initiate a cooking process; and subsequently
subsequent to said heating, baking of the envelope in a heat transfer oven.

2. A method as claimed in claim 1, wherein:
the rising of the dough of takes place through a treatment with electromagnetic waves.

3. A method as claimed in claim 2, wherein:
the rising process of the dough takes place concurrently with the heating of the filling by electromagnetic waves.

4. A method as claimed in claim 1, wherein:
the operations are realized as a semi-continuous process.

5. A method as claimed in claim 1, wherein:
the operations are realized as a continuous process.

6. A method as claimed in claim 1, wherein:
the heating takes less than 3½ minutes.

7. A method as claimed in claim 1, wherein: the heating takes at least 3 minutes.

8. A method as claimed in claim 1, further comprising:
transported transporting product from an electromagnetic wave oven to a heat-transfer oven.

9. A method as claimed in claim 1, wherein:
the heating is carried out serially, and the baking is carried out in parallel after rearrangement of products employing a series-to-parallel conversion.

10. A method as claimed in claim 1, wherein:
the filling comprises a meat product.

11. A method as claimed in claim 1, wherein:
during the heating, the humidity of the atmosphere surrounding the product is maintained at a high level.

12. A bakery product comprising:
an envelope and a filling, said envelope at least substantially made of dough:
wherein the filling is heated by means of electromagnetic waves so as to initiate a cooking process, and the envelope is baked in a heat transfer oven subsequent to the heating.

13. A bakery product as claimed in claim 12, wherein:
the filling comprises a meat product.

14. A system for baking product comprising:
a first oven for heating an uncooked product including an envelope and a filling, said envelope at least substantially made of dough, said first oven heating the filling by means of electromagnetic waves so as to initiate a cooking state; and
a second oven for baking the envelope by means of heat transfer.

15. A system as claimed in claim 14, further comprising:
transport means for transporting the product from said first oven to said second oven.

16. A system as claimed in claim 15, wherein:
said transport means comprises a series-to-parallel converter.
